(19) United States
(12) Patent Application Publication
(10) Pub. No.: US 2012/0315212 A1
(43) Pub. Date: Dec. 13, 2012

(54) DIAMOND PARTICLES AND METHOD FOR OBTAINING DIAMOND PARTICLES FROM AGGREGATE STRUCTURES

(75) Inventor: Oliver Williams, Penarth (GB)

(73) Assignee: Fraunhofer-Gesellschaft Zur Forderung Der Angewandten Forschung E.V., Munich (DE)

(21) Appl. No.: 13/579,705

(22) PCT Filed: Jan. 25, 2011
(86) PCT No.: PCT/EP2011/000286

§ 371 Date: Aug. 17, 2012

(30) Foreign Application Priority Data
Feb. 19, 2010 (DE) 10 2010 008 682.7

(51) Int. Cl. C01B 31/06; C01B 31/00

(52) U.S. Cl. 423/446

(57) ABSTRACT

A method for obtaining diamond particles from aggregate structures which contain diamond particles with an average particle diameter of less than 10 nm. The aggregate structures are heated under a gas atmosphere such that the diamond particles are obtained from the aggregate structures. It is essential that the aggregate structures are heated under a gas atmosphere which, in terms of reactive gases, contains hydrogen gas in a proportion of at least 80%.

### BACKGROUND

The invention relates to a method for obtaining diamond particles from aggregate structures, which include diamond particles with an average particle diameter of less than 10 nm as well as diamond particles.

Since the discovery of diamond particles with an average particle diameter of less than 10 nm in soot yielded via the detonation method, processes have been developed for the commercial production of powder with highly dispersed diamond particles. These powders named UDD (Ultra Dispersed Diamond) are used in a wide range of applications, such as pharmaceuticals or material technology for the formation of thin layers of diamond.

The name “diamond particles” comprises diamond-like particles as well as particles comprising a diamond core with a graphite surface.

The commercial UDD-powders presently available are disadvantageous in that, although they comprise nano-diamond particles, i.e. diamond particles with an average particle diameter of less than 10 nm, these diamond particles are present in considerably larger aggregate structures. The aggregate structures show a typical size of more than 100 nm and typically include a plurality of nano-diamond particles. These aggregate structures typically develop in the production process of the UDD-powders during the cooling stage after the detonation blast wave.

However, the presence of mono-dispersed diamond particles is necessary for a plurality of potential fields of application so that methods have been developed for obtaining nano-particles from the above-mentioned aggregate structures.

For example, it is known to obtain nano-diamond particles from the above-mentioned aggregate structures using a wet-type milling method, such as described for example in Kruger, A., F. Kataoka, M. Ozawa, T. Fujino. Y. Suzuki, A. E. Aleksenskii, A. Y. Vul.”, and E. Osawa, CARBON, 2005, 43(8); p. 1722-1730 and U.S. Pat. No. 7,300,958.

In this method the disadvantage develops that due to the milling process contaminants, particularly zirconium oxide develops, which cannot be removed or only with great expense.

Another known method is to oxidize UDD-powders in an air atmosphere at a temperature range from 400° C. to 450° C., as described for example in Osswald, S., G. Yushin, V. Mochalin, S. O. Kucheyev and Y. Gogotsi, Journal of the American Chemical Society, 2006, 128(35); p. 11635-11642 and WO2007/133765. However, in this method a high loss of the source material occurs and furthermore a precise compliance with the prescribed temperature window is necessary.

The further development of applications for nano-diamond particles essentially depends on a cost-effective way of obtaining of mono-dispersed nano-diamond particles.

### SUMMARY

The present invention is therefore based on the objective to provide diamond particles with an average particle diameter of less than 10 nm and a method for obtaining such diamond particles from aggregate structures which eliminate the above-mentioned disadvantages and can be realized in a technically simple and cost-effective fashion compared to methods of prior art.

This objective is attained in a method for obtaining diamond particles from aggregate structures, which yield diamond particles with an average particle diameter of less than 10 nm according to the invention as well as by the resulting diamond particles. Advantageous embodiments of the method according to the invention are described below. An advantageous embodiment of the diamond particles is found also described below.

The method according to the invention serves to obtain diamond particles from aggregate structures, which contain diamond particles with an average particle diameter of less than 10 nm. Here, the aggregate structures are heated under a gas atmosphere so that the diamond particles are obtained from the aggregate structures. It is essential that the aggregate structures are heated under a gas atmosphere which comprises hydrogen gas in the reactive gases at a portion of at least 80%.

The term “diamond particles” includes here and in the following diamond-like particles as well as particles comprising a diamond core with a graphite surface. The term “reactive gases” here and in the following relates to such gases that react to the aggregate structures and/or the diamond particles.

In the past it was assumed that obtaining the diamond particles from the aggregate structures was possible at best under thermal influence at a narrow temperature window at an oxygen atmosphere. In particular, it has shown that using purely wet-chemical methods with surface treatment means cannot succeed in obtaining diamond particles from the aggregate structures.

The method according to the invention is based on the knowledge of the applicant that surprisingly in diamond particles of less than a certain size a chemical reaction with the H₂-molecules of the hydrogen gas is possible under a gas atmosphere comprising hydrogen gas, resulting in two positive effects:

On the one hand, the diamond particles are obtained with an average particle diameter of less than 10 nm from the aggregate structures. Furthermore, by a reaction with the H₂-molecules a treatment of the surface of the diamond particles occurs as well, which leads to advantageous features with regards to wetting behavior, friction behavior, and electronic features.

Accordingly, by the heating of the aggregate structures under a gas atmosphere comprising hydrogen gas in the method according to the invention, on the one hand, diamond particles are obtained from the aggregate structures and, on the other hand, the surfaces of the diamond particles are beneficially modified.

The experiments of the applicant have shown that from commercially available UDD-powders with aggregate structures above 100 nm using the method according to the invention, after the dispersion of the diamond particles obtained in a liquid and subsequent centrifuging, mono-dispersed diamond particles could be obtained with an average particle diameter of less than 10 nm. Furthermore, measurements have shown that the diamond particles obtained by the method according to the invention, at least for pH-values 3 to 7, show a zeta-potential of more than +30 mV.

The zeta-potential as the measurement of the electric potential of a moved particle in a suspension is an indication for the stability of the diamond particles in the liquid after centrifuging, particularly in the context with diamond particles. Untreated commercially available UDD-powders typically show negative zeta-potentials. The diamond particles obtained via the method according to the invention show high positive zeta-potentials exceeding +30 mV after centrifuging in the liquid, though, which proves the high stability of the dispersed diamond particles obtained and thus their wide application for further processing. These high zeta-potentials are caused by a reaction of the surface of the diamond particles with the H₂-molecules of the hydrogen gas of the gas atmosphere in the method according to the invention.

Using the method according to the invention it is therefore possible for the first time to obtain diamond particles from the aggregate structures by the technically inexpensive heating of the aggregate structures under a gas atmosphere containing hydrogen gas, showing an average particle diameter of less than 10 nm and an advantageously modified surface, particularly with a zeta-potential exceeding +30 mV (at least in measurements after dispersing the diamond particles obtained in a liquid and centrifuging).

Contrary to methods of prior art the obtaining of the diamond particles are obtained by the effect of the hydrogen gas during the heating process. For this purpose, the gas atmosphere shows a content of at least 80% hydrogen gas in the reactive gases during the heating process. The percentage relates here and in the following to the percentage of particles.

In order to avoid any other reactions beside the desired obtaining of diamond particles by the impact of hydrogen gas the gas atmosphere preferably comprises hydrogen gas at a portion of at least 90%, preferably at least 99%, furthermore at least 99.9% of the reactive gases. In particular the heating is advantageous in a pure or almost pure hydrogen gas atmosphere.

Contrary to methods of prior art, in the method according to the invention particularly the oxidation of the aggregate structures and/or the diamond particles by oxygen gas and/or other oxidizing gases shall be avoided. Preferably the portion of oxidizing gases in the reactive gases of the gas atmosphere is less than 5%, preferably less than 3%, particularly less than 1%. In particular, preferably the portion of oxygen gas in the reactive gases amounts to less than 5%, preferably less than 3%, particularly less than 1%.

Preferably in the method according to the invention the aggregate structures are heated to a temperature ranging from 400° C. to 1000° C., preferably to a temperature from 400° C. to 600° C., preferably to approximately 500° C. This way, optimal processing conditions result for obtaining diamond particles from the aggregate structures. The experiments of the applicant have shown that in the method according to the invention particularly a greater temperature window is possible compared to the method of prior art for treating aggregate structures under an oxygen gas atmosphere.

Preferably, in the method according to the invention the aggregate structures are heated for a term ranging from 1 hour to 24 hours, preferably from 1 hour to 10 hours, preferably for approximately 5 hours. This leads to an optimization for a high effectiveness of the method, on the one hand, and a low processing duration, on the other hand.

The heating under a gas atmosphere preferably occurs at a pressure ranging from 5 mbar to 20 bar, preferably from 5 mbar to 2 bar, preferably at approximately 10 mbar. It also shows with regards to the pressure range that here a wide window is possible for the pressure parameters in the method according to the invention so that here too the expense for devices to perform the method according to the invention is low compared to methods using a very precise pressure control.

Preferably, in the method according to the invention the heating occurs under a gas atmosphere in a reaction chamber. In particular, preferably in the reaction chamber first a vacuum is generated with a pressure of less than 10⁻⁷ mbar, preferably less than 10⁻⁶ mbar, preferably less than 10⁻⁵ mbar, and subsequently the heating occurs under a gas atmosphere at a pressure exceeding 1 mbar, in particular preferably at a pressure according to the above-mentioned pressure ranges. By heating the vacuum it is achieved that only a negligibly small contamination of the gas atmosphere is given in the reaction chamber when the method according to the invention is performed.

Preferably, the heating under a gas atmosphere occurs as described above in a reaction chamber, with hydrogen gas being continuously guided through the reaction chamber during the heating of the aggregate structures. Experiments of the applicant have shown that preferably hydrogen gas with a flow rate from 10 sccm (standard cubic centimeters per minute) and 100 sccm, preferably from 30 sccm to 60 sccm, particularly of approximately 50 sccm is guided through the reaction chamber.

In order to ensure constant processing conditions, preferably during the conveyance of hydrogen, the pressure in the reaction chamber is kept approximately constant.

In order to avoid interferences during the heating process of the aggregate structures under a gas atmosphere by foreign substances in the method according to the invention preferably hydrogen gas is used with a purity of at least 99.9%, preferably at least 99.99999%, further preferred at least 99.999999%. Preferably the cleaning of the hydrogen gas occurs via a palladium membrane prior to introduction into the reaction chamber.

The diamond particles obtained by heating the aggregate structures in a gas atmosphere are then preferably dispersed in a liquid. Particularly preferred the diamond particles are dispersed in deionized water.

The dispersing occurs preferably by an impact of ultrasound. Here, methods and devices of prior art may be used.

In particular the dispersing via high-performance ultrasound is advantageous, preferably with a capacity exceeding 200 W, particularly exceeding 250 W. Preferred treatment periods with ultrasound range from 1 to 20 hours, preferably from 3 to 7 hours.

Furthermore, advantageously after the dispersing process of the diamond particles in a liquid, centrifuging of the liquid with the diamond particles occurs. Particularly advantageous is centrifuging at a range from 5000 rpm to 15000 rpm, preferably at least at 10000 rpm.

The diamond particles obtained via the method according to the invention are preferably dispersed in a liquid and preferably exhibit an average particle diameter of less than 10 nm, preferably less than 8 nm, preferably ranging from 2 nm to 5 nm.

In particular the diamond particles obtained via the method according to the invention, due to the treatment in the gas atmosphere, show a zeta-potential exceeding +30 mV, preferably exceeding +50 mV, particularly at a pH-range from 3 to 7.

### BRIEF DESCRIPTION OF THE DRAWINGS

In the following, additional advantageous features and embodiments of the invention are explained in greater detail based on the exemplary embodiments and the figures. Here it shows:

FIG. 1 a transmission electron microscopic image of untreated UDD-powder;

FIG. 2 a transmission electron microscopic image of UDD-powder treated with the method according to the invention;

FIG. 3 a comparison of the zeta-potentials of treated and untreated UDD-powder depending on the pH-values, and

FIG. 4 a size distribution of the diamond particles in treated UDD-powder after centrifuging at different rotations during the centrifuging process.

### DETAILED DESCRIPTION OF THE PREFERRED EMBODIMENTS

Commercially available UDD-powder of the type “GO1 Grade” was obtained from Plasmachem GmbH. 0.4 g UDD-powder was placed into a reaction chamber embodied as a vacuum kiln and a vacuum was generated of less than 1×10⁻⁶ mbar. Subsequently hydrogen gas was introduced with a purity being generated of 99.999999% using a palladium membrane. The hydrogen gas was conveyed with 50 sccm through the reaction chamber, with a pressure was maintained of 10 mbar. Using resistance heating the aggregate structures of the UDD-powder was heated to 500° C., with the temperature being measured using a single-wavelength pyrometer. The heating under a gas atmosphere with the above-stated parameters occurred for a term of 5 hours.

Subsequently the cooling to room temperature occurred with the hydrogen gas flow being maintained; subsequently once more a vacuum was generated (less than 10⁻³ mbar) and the reaction chamber was ventilated.

Subsequently, aqueous colloids were generated, on the one hand, from the UDD-powder treated as described above using the method according to the invention and, on the other hand, from untreated UDD-powder, by 0.1 g powder being added to 200 ml deionized water and subsequently dispersion occurred respectively via high-power ultrasound (Sonics Vibra Cell VCX500). The parameters of the dispersion were a power of 250 W with a Duty Cycle of 3:2 (on:off) for a period of 5 hours at a permanent cooling of the liquid. The temperature of the liquid was here kept below 20° C.

The two sample liquids were then left standing for 24 hours in order to allow precipitation and subsequently decanting of contaminants, for example contaminants cased by material from the sonotrode, particularly titanium alloy.

After decanting the two liquids were centrifuged for 90 minutes at different speeds ranging from 5000 to 15000 rpm in a universal centrifuge device “320 R”.

The measurement of the particle size and the zeta-potential of the dispersed diamond particles occurred respectively via dynamic light diffraction (BLS) using a Malvern Zetasicer Nano ZS device in the backscatter configuration) (173°. The particle size was here averaged by 100 measuring processes of 30 seconds each and the measurements of the zeta-potential occurred by averaging 300 measurements. A diffraction index of 2.4 for diamond was used to convert the sizes of measured intensity/size distribution in the number of particles/size distribution. The measurements of the zeta-potential were calibrated via an aqueous suspension of polymer micro-spheres at a pH-value of 9.2, with referencing occurred by the standard NIST1980.

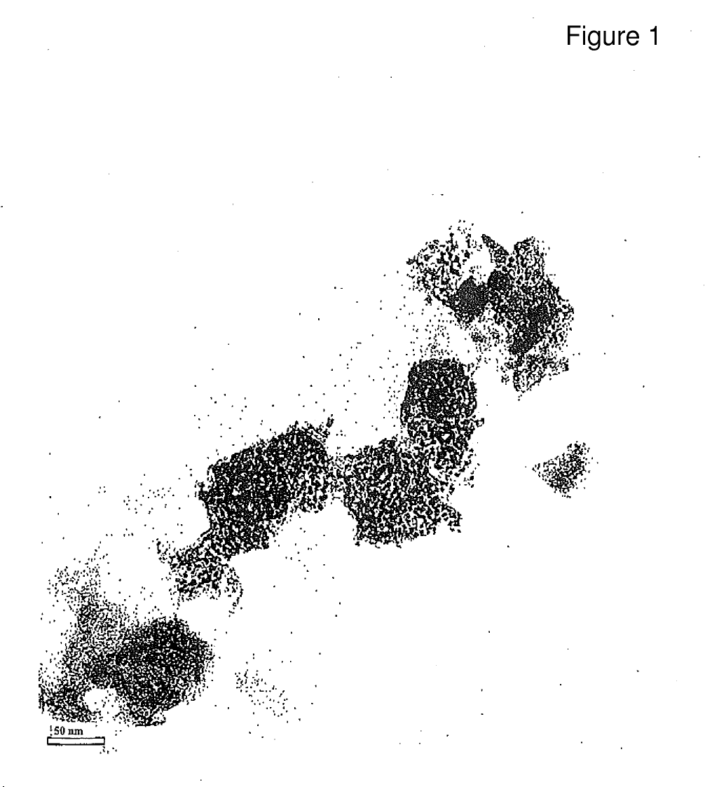

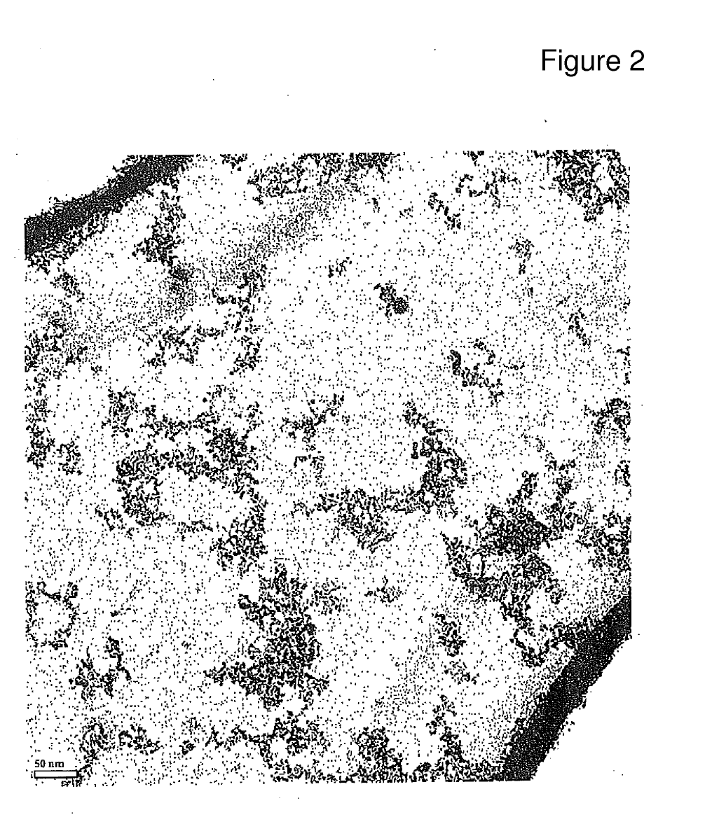

In FIGS. 1 and 2, respectively at the bottom left, a white bar is shown as a scale for a length of 50 nm.

The transmission electron image in FIG. 1 shows that in the untreated UDD-powder densely packed aggregates are given exceeding 100 nm. Individually present diamond particles could not be observed.

However, UDD-powder treated with the method according to the invention shows clearly smaller particle sizes in the transmission-electron image according to FIG. 2, with regarding the image according to FIG. 2 it must be pointed out that a slight collection of particles occurred during the drying process for generating the image due to the surface tension of water. However, FIG. 2 already clearly shows that the aggregate structures are considerably smaller compared to FIG. 1 and furthermore individual diamond particles are discernible. The aggregation density is therefore considerably reduced.

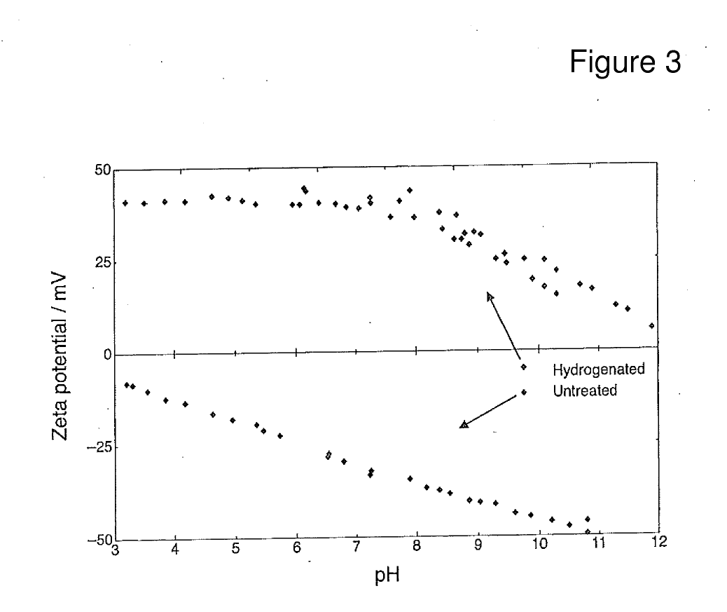

In FIG. 3 the zeta-potentials measured in mV are shown in reference to the pH-value. Here, the measuring points above the central, horizontal line show the positive zeta-potentials of the UDD-powder (hydrogenated) treated with the method according to the invention, while the measuring points underneath the central, horizontal line show the negative zeta-potentials of the untreated UDD-powder (untreated).

The untreated UDD-powder therefore shows a negative zeta-potential over the entire pH-range measured, with the zeta-potential becoming more negative with increasing pH-values. This is known in commercially available UDD-powders, which have been cleaned by acid treatment.

The UDD-powder treated with the method according to the invention shows positive zeta-potentials over the entire pH-range measured, though, with in a pH-range from 3 to 7 consistently zeta-potentials of more than +40 mV were measured. The zeta-potentials at high pH-values shows falling measurements, with here it could be observed that a degradation of the measuring electrode occurred during the measuring process such that the measurements at high pH-values perhaps are flawed.

Furthermore, immediately after the centrifuging of the UDD-powder treated with the method according to the invention zeta-potentials were measured up to +70 mV. The lower values in FIG. 3 of UDD-powder treated with the method according to the invention are perhaps caused by a slight contamination during the refilling of the liquid with the dispersed diamond particles and an exposure to air.

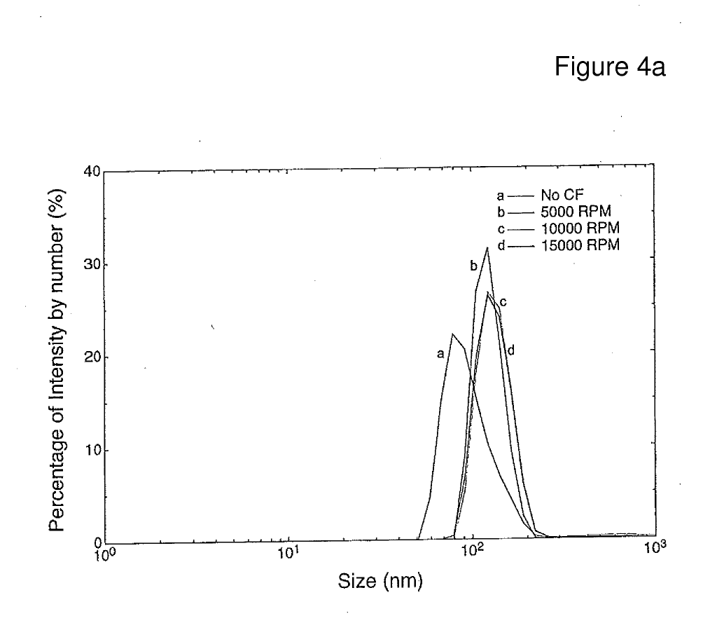

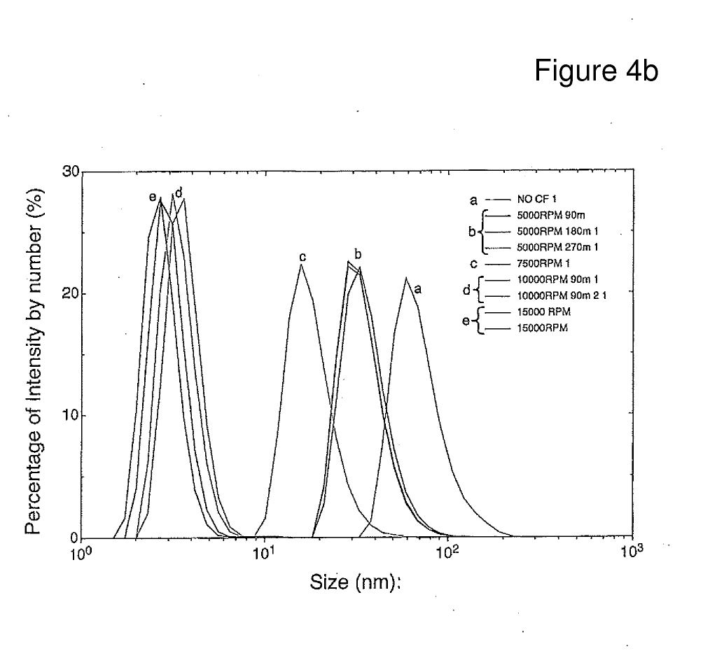

In FIGS. 4a and 4b the size of the diamond particle (“size”) is shown in nm. Here, FIG. 4a shows the size distribution of the diamond particles of untreated UDD-powder (“No CF”) and after repeated centrifuging with different rotations (each with the rotation being stated in U/min “rpm”). It is discernible from FIG. 4a that the particle size is essentially independent from centrifuging. The dominant particle size here exceeds 100 nm and there is no indication for smaller particles.

However, FIG. 4b shows the size distribution in the UDD-powder treated with the method according to the invention in reference to various centrifuging processes, with the rotation during centrifuging for the individual measuring curves is stated (in “rpm”) and the duration of the centrifuging process in minutes (m).

In FIG. 4b it is clearly discernible that even prior to the centrifuging process (“no CF”) the average particle size is less than 100 nm (approximately 58 nm) and thus already considerably below the average particle size of the untreated UDD-powder.

After centrifuging the average value of the particle size measured amounts to considerably lower values. For example the average value of the particle size after centrifuging at 5000 rpm ranges from approximately 28 nm to 32 nm, after centrifuging at 7500 rpm amounts to approximately 16 nm, and subsequently this value reduces to 2 nm to 4 nm after centrifuging with rotations above 10000 rpm.

This way it is shown that by the centrifuging process with rotations exceeding 1000 rpm and for a period of at least 90 minutes completely mono-dispersed colloids can be assumed.

1. A method to obtain diamond particles from aggregate structures, which comprise diamond particles with an average particle diameter of less than 10 nm, the method comprising heating aggregate structures under a gas atmosphere such that the diamond particles are obtained from the aggregate structures, wherein the aggregate structures are heated under the gas atmosphere, which comprises in its reactive gases hydrogen gas at a portion of at least 80%.

2. A method according to claim 1, wherein the aggregate structures are heated under the gas atmosphere, which comprises reactive gases containing hydrogen gas at a portion of at least 90%.

3. A method according to claim 1, wherein the aggregate structures are heated under the gas atmosphere, with the reactive gases having a portion of oxidizing gases of less than 5%.

4. A method according to claim 1, wherein the aggregate structures are heated to a temperature ranging from 400° C. to 1000° C.

5. A method according to claim 4, wherein the aggregate structures are heated for a period ranging from 1 hour to 24 hours.

6. A method according to claim 5, wherein the heating occurs under the gas atmosphere at a pressure ranging from 5 mbar to 20 mbar.

7. A method according to claim 1, wherein the heating occurs under the gas atmosphere in a reaction chamber, with in the reaction chamber first a vacuum is generated with a pressure of less than 10⁻⁷ mbar, and subsequently the heating occurs under the gas atmosphere at a pressure exceeding 1 mbar.

8. A method according to claim 1, wherein the heating occurs, under a gas atmosphere in a reaction chamber, and during the heating process of the aggregate structures hydrogen gas is continuously conveyed through the reaction chamber, preferably such that hydrogen is conveyed through the reaction chamber at a flow rate ranging from 10 sccm to 100 sccm.

9. A method according to claim 8, wherein during the conveyance of hydrogen the pressure inside the reaction chamber is kept approximately constant.

10. A method according to claim 1, wherein for the generation of the gas atmosphere hydrogen gas is used with a purity of at least 99.9%.

11. A method according to claim 1, wherein in a processing step A the aggregate structures are heated under the gas atmosphere and in a processing step B the diamond particles obtained in the processing step A are dispersed in a liquid.

12. A method according to claim 11, wherein in the processing step B the diamond particles obtained in the processing step A are dispersed in deionized water.

13. A method according to claim 12, wherein in the processing step B the diamond particles are dispersed by the influence of ultrasound.

14. A method according to claim 11, wherein in a processing step C centrifuging occurs of the liquid with the diamond particles.

15. A method according to claim 14, wherein in the processing step C the centrifuging occurs with a rotation ranging from 5000 rpm to 15000 rpm.

16. A method according to claim 15, wherein the diamond particles exhibit an average particle diameter of less than 8 nm.

17. Diamond particles obtained by a method according to claim 1, wherein the diamond particles are dispersed in a liquid and exhibit an average particle diameter of less than 10 nm.

18. Diamond particles according to claim 17, wherein the diamond particles show a zeta-potential greater +30 mV as a result of the treatment in the gas atmosphere.

19. A method according to claim 1, wherein the diamond particles have a graphite surface.

20. A method according to claim 1, wherein the aggregate structures are heated under the gas atmosphere which comprises reactive gases containing hydrogen gas at a portion of at least 99%.
